(19) United States
(12) Patent Application Publication
(10) Pub. No.: US 2021/0306301 A1
(43) Pub. Date: Sep. 30, 2021

(54) RELAY APPARATUS, RELAY SYSTEM, AND NON-TRANSITORY COMPUTER READABLE MEDIUM

(71) Applicant: FUJIFILM BUSINESS INNOVATION CORP., Tokyo (JP)

(72) Inventors: Kazuhiro KANEKO, Kanagawa (JP); Naoki FUSHIMI, Kanagawa (JP)

(73) Assignee: FUJIFILM BUSINESS INNOVATION CORP., Tokyo (JP)

(21) Appl. No.: 17/060,196

(22) Filed: Oct. 1, 2020

(30) Foreign Application Priority Data
Mar. 26, 2020 (JP) 2020-055399

(51) Int. Cl. H04L 29/06

(52) U.S. Cl. CPC H04L 63/0272; H04L 63/0435; H04L 63/20; H04L 63/0876

(57) ABSTRACT

A relay apparatus includes a processor configured to: receive reservation information that designates a server apparatus, a terminal connected to the relay apparatus by a communication network, and a period in which the server apparatus and the relay apparatus are connected over a virtual private network (VPN), and that reserves the period; and, in response to a request, in the period designated by the received reservation information, from the terminal designated by the reservation information, for a connection over the VPN to the server apparatus designated by the reservation information, connect the server apparatus and the relay apparatus over the VPN and relay communication between the terminal and the server apparatus over the period.

### CROSS-REFERENCE TO RELATED APPLICATIONS

This application is based on and claims priority under 35 USC 119 from Japanese Patent Application No. 2020-055399 filed Mar. 26, 2020.

### BACKGROUND

### (i) Technical Field

The present disclosure relates to a relay apparatus, a relay system, and a non-transitory computer readable medium.

### (ii) Related Art

To participate in the network of a company or the like via a public network such as the Internet from a terminal at a base open to an unspecified number of users, such as a shared office, a virtual private network (hereinafter abbreviated as a VNP) may be configured on the public network in order to prevent eavesdropping, unauthorized use, and so forth. For example, Japanese Unexamined Patent Application Publication No. 2004-274448 discloses technology intended to improve VPN security.

By the way, a user may use a terminal owned by the user to access the network of a company from a shared office or the like via a VPN to perform a task. In general, client software (referred to as a VPN client) installed in a terminal for configuring a VPN is different for each company. For example, a freelance engineer to whom tasks are delegated from a plurality of companies at the same time needs to make settings that are different for each company in a terminal used by the user. If this freelance engineer connects his/her terminal to the networks of different companies via a VPN at the same time, there is a risk of leakage of information of these companies via the terminal. Furthermore, a freelance engineer who has once set a VPN client for a certain company in his/her terminal may be able to participate in that company's network from the terminal even at an unintended time such as after the contract.

### SUMMARY

Aspects of non-limiting embodiments of the present disclosure relate to enabling, even if a user does not set his/her terminal, the terminal to connect to a server apparatus within the network of a company while ensuring security according to a dedicated communication network.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a relay apparatus including a processor configured to: receive reservation information that designates a server apparatus, a terminal connected to the relay apparatus by a communication network, and a period in which the server apparatus and the relay apparatus are connected over a virtual private network (VPN), and that reserves the period; and, in response to a request, in the period designated by the received reservation information, from the terminal designated by the reservation information, for a connection over the VPN to the server apparatus designated by the reservation information, connect the server apparatus and the relay apparatus over the VPN and relay communication between the terminal and the server apparatus over the period.

### BRIEF DESCRIPTION OF THE DRAWINGS

An exemplary embodiment of the present disclosure will be described in detail based on the following figures, wherein:

FIG. 1 is a diagram illustrating an exemplary overall configuration of a relay system;

FIG. 2 is a diagram illustrating an exemplary configuration of a reservation apparatus;

FIG. 3 is a diagram illustrating an exemplary user database (DB);

FIG. 4 is a diagram illustrating an exemplary connection definition DB;

FIG. 5 is a diagram illustrating an exemplary security policy DB;

FIG. 6 is a diagram illustrating an exemplary reservation information DB;

FIG. 7 is a diagram illustrating an exemplary configuration of a terminal;

FIG. 8 is a diagram illustrating an exemplary configuration of a server apparatus;

FIG. 9 is a diagram illustrating an exemplary configuration of a relay apparatus;

FIGS. 10A, 10B, and 10C are diagrams each illustrating an exemplary reservation information DB;

FIG. 11 is a diagram illustrating an exemplary relay state DB;

FIG. 12 is a diagram illustrating an exemplary functional configuration of the reservation apparatus;

FIG. 13 is a diagram illustrating an exemplary functional configuration of the relay apparatus;

FIG. 14 is a flowchart illustrating an exemplary flow of the operation of an authentication process performed by the reservation apparatus;

FIG. 15 is a flowchart illustrating an exemplary flow of the operation of a reservation process performed by the reservation apparatus;

FIG. 16 is a diagram illustrating an exemplary reservation screen;

FIG. 17 is a diagram illustrating exemplary detailed settings on the reservation screen;

FIG. 18 is a flowchart illustrating an exemplary flow of the operation of a reservation information sending process performed by the reservation apparatus;

FIG. 19 is a flowchart illustrating an exemplary flow of the operation of a reservation information registering process performed by the reservation apparatus;

FIG. 20 is a flowchart illustrating an exemplary flow of the operation of accepting or rejecting reservation information by a processor;

FIG. 21 is a flowchart illustrating an exemplary flow of the operation of scanning a database; and

FIG. 22 is a flowchart illustrating an exemplary flow of the operation of a selected reservation information inspecting process.

### DETAILED DESCRIPTION

### Exemplary Embodiment

### Configuration of Relay System

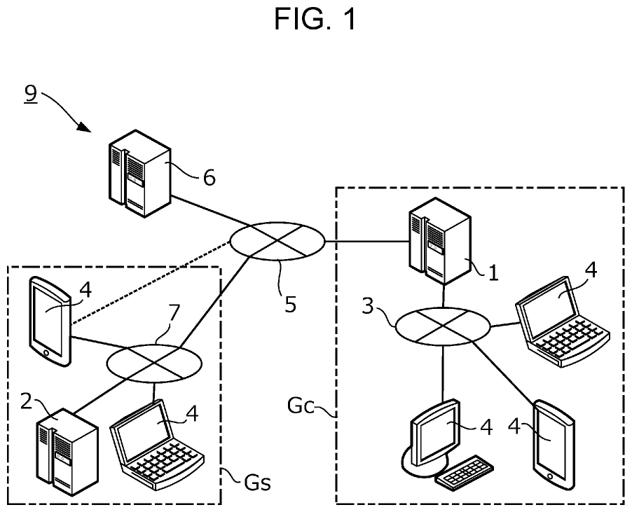

FIG. 1 is a diagram illustrating an exemplary overall configuration of a relay system 9. The relay system 9 illustrated in FIG. 1 is a system that relays communication between an information processing apparatus such as a computer managed in an organization such as a company and a terminal connected to a base such as a shared office over a VPN. The relay system 9 includes, as illustrated in FIG. 1, a relay apparatus 1, a server apparatus 2, a first communication network 3, terminals 4, a communication line 5, a reservation apparatus 6, and a second communication network 7.

The relay system 9 illustrated in FIG. 1 also includes a client organization Gc and a server organization Gs. The relay apparatus 1 and the first communication network 3 illustrated in FIG. 1 belong to the client organization Gc. The server apparatus 2 and the second communication network 7 illustrated in FIG. 1 belong to the server organization Gs. Each of the terminals 4 illustrated in FIG. 1 may be used by both of the client organization Gc and the server organization Gs, or may belong to either one of the client organization Gc and the server organization Gs.

The client organization Gc is a base used by an unspecified number of users. This base is, for example, a shared office that provides, on an hourly basis, a work space such as a booth separated by a wall, a partition, or the like, and a communication interface such as an access point, a local area network (LAN) port, or the like. When used in the client organization Gc, the terminals 4 function as a client that requests a service from the server apparatus 2.

The server organization Gs is an organization that uses the client organization Gc in so-called remote work or the like, and is, for example, a company. The server apparatus 2 belonging to the server organization Gs functions as a server that provides a service in response to a request from the terminals 4 when the terminals 4 are used in the above-mentioned client organization Gc.

The terminals 4 are terminal apparatuses that are individually used by users of the relay system 9. For example, the terminals 4 include desktop, laptop, and tablet personal computers, and mobile terminals such as smartphone.

The relay apparatus 1 is, for example, a computer, and is an information processing apparatus that relays communication between the terminal 4 connected to the relay apparatus 1 at a base used by an unspecified number of user and the server apparatus 2 managed in an organization such as a company. The relay apparatus 1 connects to the terminal 4 via the first communication network 3 and connects to the server apparatus 2 via the communication line 5 and the second communication network 7.

The first communication network 3 is a dedicated communication network that connects the relay apparatus 1 and the terminal 4 by wire or wirelessly so that they may be able to communicate with each other, and is, for example, a LAN. The first communication network 3 is used by, for example, an unspecified number of users who pay a fee. In a period where such a user is permitted to use the first communication network 3, the first communication network 3 serves as a dedicated communication network for the user because the first communication network 3 connects a specific relay apparatus 1 and a specific terminal 4 within the base.

Note that the relay apparatus 1 may function as a so-called gateway that connects the first communication network 3 and the communication line 5. Alternatively, the relay apparatus 1 may be connected to the communication line 5 by a gateway (not illustrated).

The server apparatus 2 is, for example, a computer, and is an information processing apparatus that provides, in response to a request from the terminal 4 operated by a user, a function permitted to the user.

The second communication network 7 is a dedicated communication network that connects the server apparatus 2 and the terminal 4 by wire or wirelessly so that they may be able to communicate with each other, and is, for example, a LAN. Note that the second communication network 7 is connected to the communication line 5 by a so-called gateway (not illustrated).

The communication line 5 is a public line that connects the relay apparatus 1 and the second communication network 7 so that they may be able to communicate with each other, and is, for example, the Internet. The terminal 4 has, as described above, the function of connecting to at least either of the first communication network 3 and the second communication network 7; however, as illustrated in FIG. 1, the terminal 4 may have the function of directly connecting to the communication line 5.

The reservation apparatus 6 is, for example, a computer, and is an information processing apparatus that receives a reservation to use the terminal 4 in the client organization Gc from a user via the communication line 5. The reservation apparatus 6 has, for example, the function of a so-called web server, and receives the above-mentioned reservation using a web browser or the like that runs on the terminal 4.

Therefore, the relay system 9 is an example of a relay system that includes a reservation apparatus and a relay apparatus. Note that the number of each configuration in the relay system 9 is not limited to that illustrated in FIG. 1.

### Configuration of Reservation Apparatus

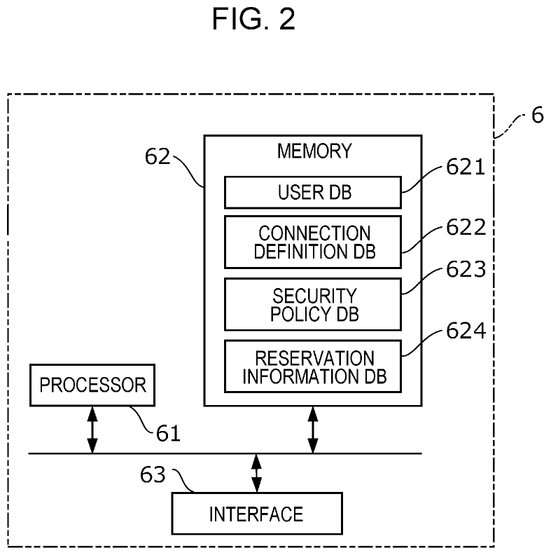

FIG. 2 is a diagram illustrating an exemplary configuration of the reservation apparatus 6. The reservation apparatus 6 illustrated in FIG. 2 includes a processor 61, memory 62, and an interface 63. These configurations are connected by, for example, a bus so that they may be able to communicate with each other.

The processor 61 controls each unit of the reservation apparatus 6 by reading and executing a computer program (hereinafter simply referred to as a program) stored in the memory 62. The processor 61 is, for example, a central processing unit (CPU).

The interface 63 is a communication circuit that connects the reservation apparatus 6 to the relay apparatus 1 and the second communication network 7 by wire or wirelessly via the communication line 5 so that they may be able to communicate with each other.

The memory 62 is a storage that stores an operating system, various programs, and data loaded by the processor 61. The memory 62 includes random-access memory (RAM) and read-only memory (ROM). Note that the memory 62 may include a solid-state drive or a hard disk drive. In addition, the memory 62 stores a user DB 621, a connection definition DB 622, a security policy DB 623, and a reservation information DB 624.

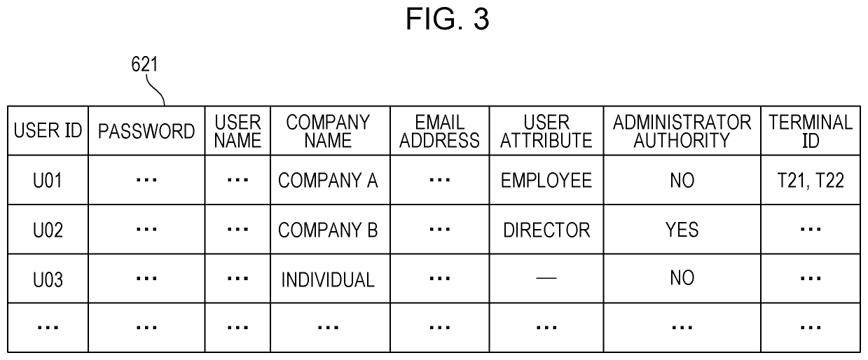

FIG. 3 is a diagram illustrating an example of the user DB 621. The user DB 621 is a database that stores information on users who use the reservation apparatus 6.

In the user DB 621 illustrated in FIG. 3, a user ID is identification information for identifying a corresponding user who uses the reservation apparatus 6. A password is data used for authenticating a user who uses the reservation apparatus 6, and is a character string or the like known only to that user. A user name is the name, nickname, or the like of a user who uses the reservation apparatus 6. A company name is the name of a company to which the above-mentioned user belongs. An email address is a character string or the like that indicates the destination of email delivered to the above-mentioned user. A user attribute is information indicating the attribute of the above-mentioned user. Administrator authority is information indicating whether the above-mentioned user is given authority as an administrator, and either “yes” or “no” is written in this item. A terminal ID is a list of items of identification information of terminals usable by the above-mentioned user.

In the user DB 621 illustrated in FIG. 3, for example, a user identified by the user ID “U01” is an “employee” who belongs to “company A” and has no administrator authority, and the terminal IDs of usable terminals are “T21” and “T22”. Note that a password in the user DB 621 may simply be authentication information used to authenticate a user, and may be replaced with information unique to the user's property, such as biometric information including the user's fingerprint, iris pattern, face shape, gait information, handwriting, and the like.

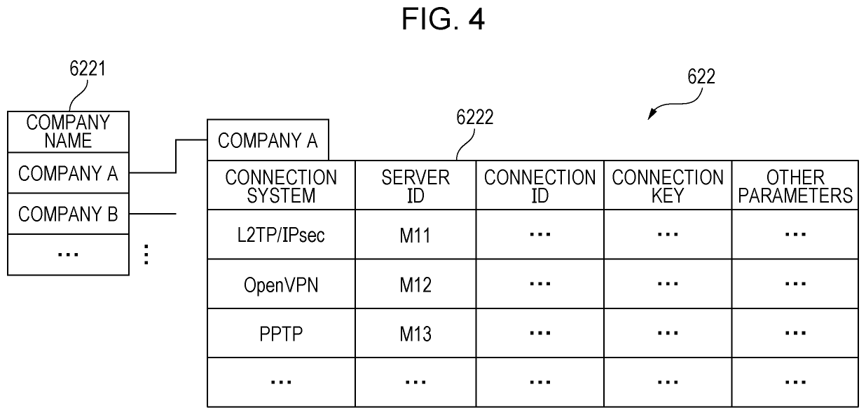

FIG. 4 is a diagram illustrating an example of the connection definition DB 622. The connection definition DB 622 is a database that associatively stores, for each organization such as a company, the server apparatus 2 to which the organization is connectable over a VPN via a public line, and the setting of the VPN for connecting to the server apparatus 2. With this connection definition DB 622, a VPN used by each server apparatus 2 is defined. The connection definition DB 622 illustrated in FIG. 4 includes a company name list 6221 and a connection definition table 6222.

In the connection definition DB 622 illustrated in FIG. 4, the company name list 6221 is a list of the names of companies using the relay system 9. Because company names in the company name list 6221 do not overlap one another, it is only necessary for these company names to function as identification information for identifying corresponding companies, and may be IDs such as identification numbers.

In the connection definition DB 622 illustrated in FIG. 4, the connection definition table 6222 is a table provided for each company identified by a corresponding company name written in the company name list 6221, and associatively stores the server apparatus 2 managed in that company and information on a VPN used for connecting to the server apparatus 2.

For example, the connection definition table 6222 illustrated in FIG. 4 is associated with company A. In this connection definition table 6222, a server ID is identification information for identifying the server apparatus 2. A connection system is the connection system of a VPN usable by the server apparatus 2 identified by a corresponding server ID. A connection ID is identification information indicating a connection with the server apparatus 2 identified by a corresponding server ID. A connection key is information referred to as a pre-shared key (PSK) or the like, which is shared between a server side and a client side in order to connect to the above-mentioned server apparatus 2 over a VPN and is used for authenticating the connection. Other parameters are other parameters used for configuring a VPN.

In the connection definition table 6222 illustrated in FIG. 4, for example, the server apparatus 2 identified by the server ID “M11” is managed by company A, and configures a VPN using the connection system “L2TP/IPsec”.

FIG. 5 is a diagram illustrating an example of the security policy DB 623. The security policy DB 623 is a database that stores, for each organization such as a company, a policy of information protection applied when the organization uses a VPN. The security policy DB 623 illustrated in FIG. 5 includes a company name list 6231 and a security policy table 6232.

In the security policy DB 623 illustrated in FIG. 5, the company name list 6231 has content common to that of the company name list 6221 of the connection definition DB 622 illustrated in FIG. 4, and is a list of the names of companies using the relay system 9.

In the security policy DB 623 illustrated in FIG. 5, the security policy table 6232 is a table provided for each company identified by a corresponding company name written in the company name list 6231, and a policy of information protection in a VPN configured by the company is defined for each user.

For example, the security policy table 6232 illustrated in FIG. 5 is associated with company A. In the security policy table 6232, a user attribute is the attribute of a user of a VPN configured by company A, and “employee”, “company B”, and “others” are written. “Addition of terminal” is information indicating whether each user who has an attribute indicated in the user attribute is permitted to add a terminal connected to the VPN. “Usable relay apparatus ID” is identification information of the relay apparatus 1 permitted to be used by each user described above. “Detailed settings” are various settings applied when each user described above uses the VPN.

Out of the detailed settings in the security policy table 6232, “breakout” is an item set as to whether to enable the function (referred to as the breakout function) of alleviating the burden on a gateway (not illustrated) in company A by allowing communication to some sites to connect to the Internet or the like (such as the communication line 5) directly from the relay apparatus 1, not via a VPN.

Out of the above-mentioned detailed settings, “access restriction” is an item set as to whether access is restricted only within a predetermined range in company A. By enabling access restriction, for example, employees of an outsourced company are guaranteed to securely execute tasks using part of the in-house system.

In addition, out of the above-described detailed settings, “stealth function” is an item set as to whether to use the function of disabling the broadcast of a service set identifier (SSID) in wireless communication compliant with IEEE 802.11. An access point whose SSID is open to the public is susceptible to so-called honeypot attacks and evil twin attacks, and there is a risk of being eavesdropped by other people. With the use of the stealth function, the SSID of an access point of wireless communication is not broadcast, and this reduces the chance for the attacker to know the SSID, compared with the case of not using the stealth function.

In the case where it has been set to use the stealth function, the reservation apparatus 6 generates a disposable SSID (may also be referred to as a one-time SSID) on every connection configuring a VPN. The reservation apparatus 6 includes the generated one-time SSID in a reservation completion email message that reports the completion of the reservation and sends it to the user's email address.

In addition, out of the above-described detailed settings, “Multiple VPN” is an item set as to how many VPNs are configured between the relay apparatus 1 and the server apparatus 2. In the case of configuring multiple VPNs on one connection, the relay system 9 may switch a to-be-used VPN according to, for example, the type of a connection route between the relay apparatus 1 and the terminal 4 and the communication load thereon.

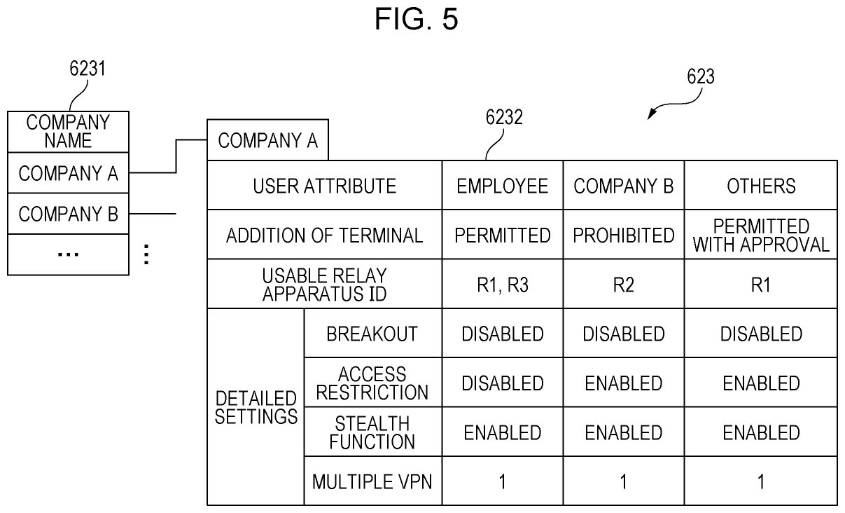

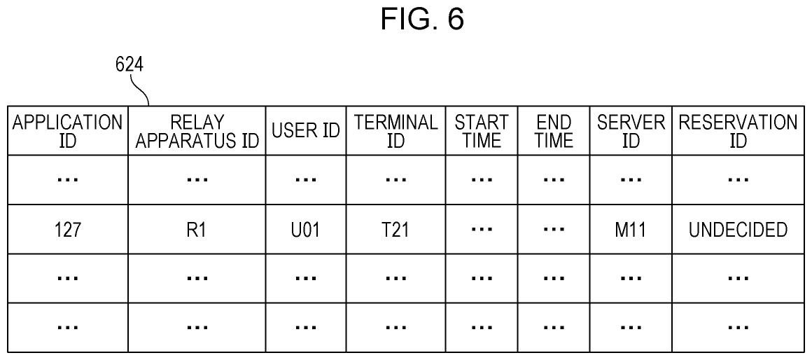

FIG. 6 is a diagram illustrating an example of the reservation information DB 624. The reservation information DB 624 is a database that stores information (referred to as reservation information) regarding a reservation accepted by the reservation apparatus 6. In the reservation information DB 624 illustrated in FIG. 6, an application ID is identification information assigned to every application for a reservation for a connection over a VPN. A relay apparatus ID is identification information for identifying the relay apparatus 1 to be connected over a VPN. A user ID is identification information for identifying a user who has applied for the reservation.

A terminal ID is identification information for identifying the terminal 4 used by a user who has applied for the reservation on a to-be-reserved connection. This terminal 4 may be the terminal 4 owned by the user, which is brought to and used in the client organization Gc on a to-be-reserved connection, but may be the terminal 4 lent out by the client organization Gc at each booth. In short, the terminal 4 is the terminal 4 used on a to-be-reserved connection when connecting from the client organization Gc to the server apparatus 2 in the server organization Gs.

A start time is the time when a connection for which the user requests a reservation is scheduled to start. An end time is the time when the above-mentioned connection is scheduled to end. A server ID is identification information for identifying the server apparatus 2 to which the user requests a connection with the terminal 4 using a VPN. A reservation ID is a reservation number assigned by the relay apparatus 1 when the relay apparatus 1 accepts a reservation, instead of rejecting it. In the example illustrated in FIG. 6, this item is “undecided” from when a reservation is applied to when the application is accepted, which indicates that the reservation information is temporarily registered. In response to writing of a reservation number in the reservation ID, the corresponding reservation information is registered.

The reservation apparatus 6 receives an inquiry from the relay apparatus 1 at regular intervals, for example, as to whether there is a reservation for a VPN using the relay apparatus 1, and searches the reservation information DB 624 for temporarily-registered reservation information indicating that reservation. In the case where the reservation apparatus 6 finds the reservation information as a result of the search, the reservation apparatus 6 sends the reservation information to the inquiring relay apparatus 1. In response to a reply from the relay apparatus 1 to accept a reservation indicated by the sent reservation information, the reservation apparatus 6 writes a reservation number included in the reply in the reservation information DB 624, which allows the reservation information to be registered. In contrast, in response to a reply from the relay apparatus 1 to reject a reservation indicated by the sent reservation information, the reservation apparatus 6 deletes the reservation information from the reservation information DB 624.

### Configuration of Terminal

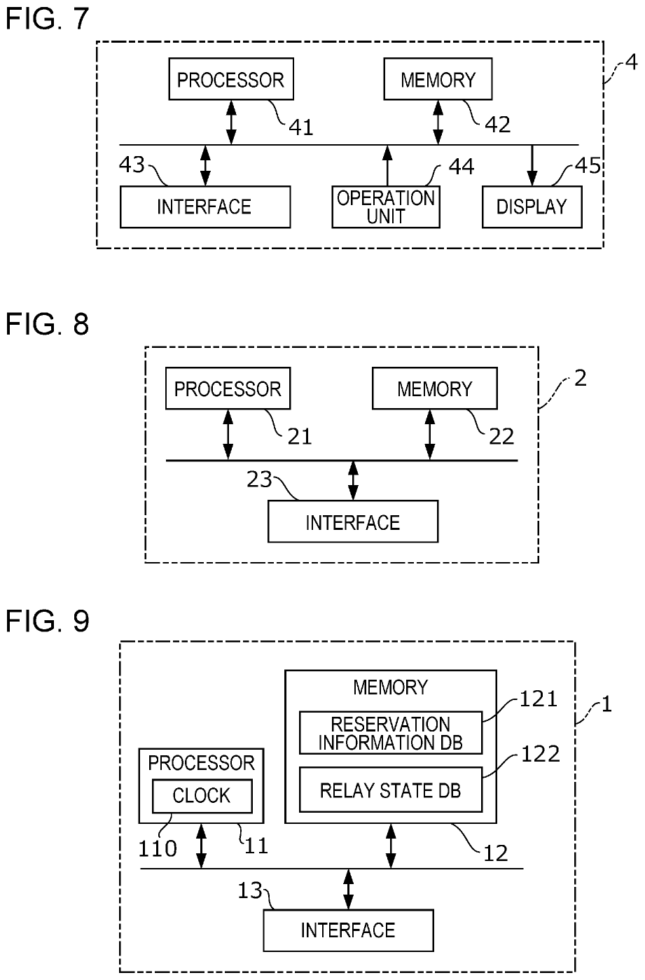

FIG. 7 is a diagram illustrating an exemplary configuration of the terminal 4. The terminal 4 illustrated in FIG. 7 includes a processor 41, memory 42, an interface 43, an operation unit 44, and a display 45. These configurations are connected by, for example, a bus so that they may be able to communicate with each other.

The processor 41 controls each unit of the terminal 4 by reading and executing a program stored in the memory 42. The processor 41 is, for example, a CPU.

The interface 43 is a communication circuit that connects the terminal 4 to another apparatus and a communication line by wire or wirelessly. In the case where the terminal 4 is used in the client organization Gc illustrated in FIG. 1, the interface 43 connects the terminal 4 to the relay apparatus 1 and the communication line 5 via the first communication network 3. In addition, in the case where the terminal 4 is used in the server organization Gs illustrated in FIG. 1, the interface 43 connects the terminal 4 to the server apparatus 2 and the communication line 5 via the second communication network 7. Note that the interface 43 may have the function of directly connecting to the communication line 5 to exchange information with the reservation apparatus 6, instead of establishing a connection via the first communication network 3 or the second communication network 7.

The operation unit 44 includes operators such as operation buttons, a keyboard, a touchscreen, and a mouse for giving various commands. The operation unit 44 receives an operation and sends a signal in accordance with the operation content to the processor 41.

The display 45 includes a display screen such as a liquid crystal display, and displays an image under control of the processor 41. A transparent touchscreen of the operation unit 44 may be arranged on the display screen in an overlapping manner.

The memory 42 is a storage that stores an operating system, various programs, and data loaded by the processor 41. The memory 42 includes RAM and ROM. Note that the memory 42 may include a solid-state drive or a hard disk drive.

### Configuration of Server Apparatus

FIG. 8 is a diagram illustrating an exemplary configuration of the server apparatus 2. The server apparatus 2 illustrated in FIG. 8 includes a processor 21, memory 22, and an interface 23. These configurations are connected by, for example, a bus so that they may be able to communicate with each other.

The processor 21 controls each unit of the server apparatus 2 by reading and executing a program stored in the memory 22. The processor 21 is, for example, a CPU.

The interface 23 includes a communication circuit that connects the server apparatus 2 to the terminal 4 via the second communication network 7 by wire or wirelessly so that they may be able to communicate with each other. In addition, since a gateway (not illustrated) is connected to the second communication network 7, using the communication circuit of the interface 23, the server apparatus 2 connects to the communication line 5 via the second communication network 7 and the above-mentioned gateway.

The memory 22 is a storage that stores an operating system, various programs, and data loaded by the processor 21. The memory 22 includes RAM and ROM. The memory 22 may include a solid-state drive or a hard disk drive.

### Configuration of Relay Apparatus

FIG. 9 is a diagram illustrating an exemplary configuration of the relay apparatus 1. The relay apparatus 1 illustrated in FIG. 9 includes a processor 11, memory 12, and an interface 13. These configurations are connected by, for example, a bus so that they may be able to communicate with each other.

The processor 11 controls each unit of the relay apparatus 1 by reading and executing a program stored in the memory 12. The processor 11 is, for example, a CPU. In addition, the processor 11 illustrated in FIG. 9 includes a clock 110 serving as a device that generates or obtains time information indicating the current time. The clock 110 is, for example, a so-called clock generator that generates a clock signal using an oscillation circuit including a crystal resonator.

The interface 13 includes a communication circuit that connects the relay apparatus 1 to the terminal 4 via the first communication network 3 by wire or wirelessly so that they may be able to communicate with each other. In addition, the interface 13 includes a communication circuit that connects the relay apparatus 1 to the communication line 5 by wire or wirelessly. Because the interface 13 has these two communication circuits, the relay apparatus 1 relays communication between the terminal 4 and the communication line 5.

The memory 12 is a storage that stores an operating system, various programs, and data loaded by the processor 11. The memory 12 includes RAM and ROM. The memory 12 may include a solid-state drive or a hard disk drive. In addition, the memory 12 stores a reservation information DB 121 and a relay state DB 122.

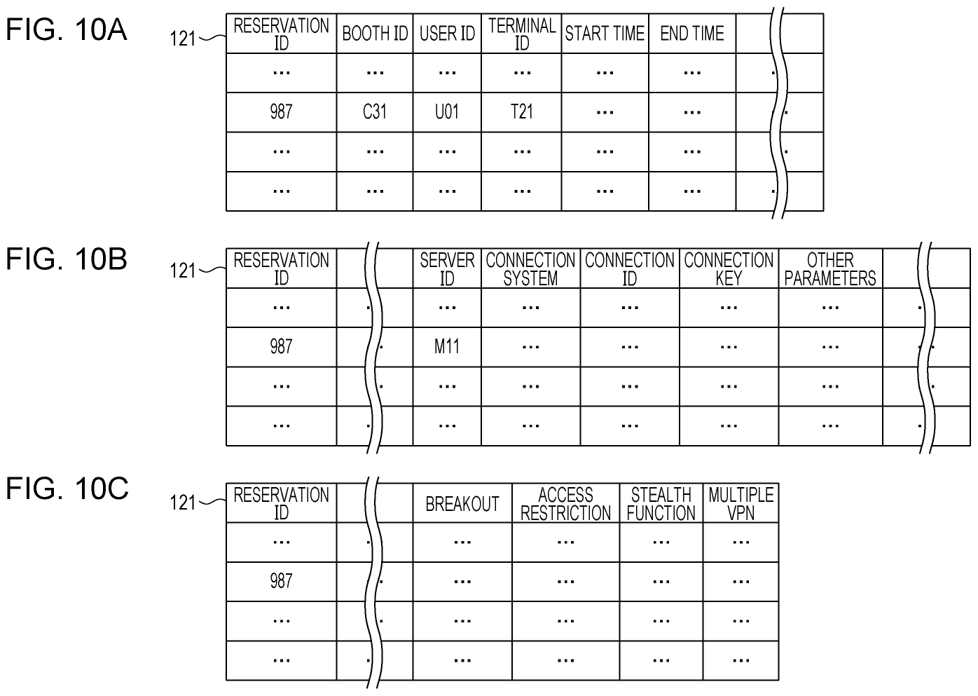

FIGS. 10A, 10B, and 10C are diagrams each illustrating an example of the reservation information DB 121. The reservation information DB 121 is a database that stores reservation information received from the reservation apparatus 6. The relay apparatus 1 makes an inquiry at regular intervals, for example, which involves digest access authentication to the reservation apparatus 6, determines whether there is a reservation for a VPN using the relay apparatus 1, and, if there is such a reservation, receives reservation information indicating the reservation from the reservation apparatus 6. Note that the relay apparatus 1 and the reservation apparatus 6 may perform authentication using basic access authentication, instead of digest access authentication.

The relay apparatus 1 checks, in a period from the start time to the end time indicated by reservation information received from the reservation apparatus 6, whether there is a facility that may use the terminal 4 designated by the reservation information. In the case where it is determined that there is a facility mentioned above, the relay apparatus 1 accepts a reservation indicated by the reservation information and registers the reservation information in the reservation information DB 121. In contrast, in the case where it is determined that there is no facility mentioned above, the relay apparatus 1 rejects a reservation indicated by the reservation information.

As described above, reservation information received from the reservation apparatus 6 and registered in the reservation information DB 121 in the memory 12 of the relay apparatus 1 at least includes a server ID, a terminal ID, a start time, and an end time. That is, this reservation information is an example of reservation information that designates a server apparatus, a terminal connected to a relay apparatus by a communication network, and a period in which the server apparatus and the relay apparatus are connected over a VPN, and that reserves the period.

In FIGS. 10A, 10B, and 10C, a plurality of items constituting one reservation information DB 121 are illustrated separately for each classification to which these items belong.

FIG. 10A illustrates an item describing basic information of a reservation in the reservation information DB 121. In the reservation information DB 121 illustrated in FIG. 10A, a reservation ID is identification information for identifying reservation information obtained from the reservation apparatus 6, which is assigned when the reservation information is registered. A booth ID is identification information for identifying a booth that is a work space assigned to a user who has applied for the reservation in the client organization Gc such as a shared office to which the relay apparatus 1 belongs. A user ID is identification information of a user who has applied for the reservation. A terminal ID is identification information of a terminal 4 scheduled to be used by a user who has applied for the reservation in a reserved period. A start time and an end time are the time at which the reservation starts and ends.

In addition, FIG. 10B illustrates an item describing information regarding a reserved connection in the reservation information DB 121. In the reservation information DB 121 illustrated in FIG. 10B, a server ID is identification information of the server apparatus 2 requested to be connected to the terminal 4 designated by the user in a reservation. A connection system, a connection ID, a connection key, and other parameters are information corresponding to a server ID included in reservation information, which are extracted by the reservation apparatus 6 according to the server ID from the connection definition table 6222 of the connection definition DB 622.

In addition, FIG. 10C illustrates an item describing information regarding detailed information in the reservation information DB 121. In the reservation information DB 121 illustrated in FIG. 10C, breakout, access restriction, stealth function, and multiple VPN are all information extracted from the security policy table 6232, which are associated with the company name of a company to which a user who has applied for the reservation belongs, in the security policy DB 623, and are detailed information corresponding to the user's attribute.

For example, in the case where the stealth function is enabled in the above-mentioned reservation information DB 121, the relay apparatus 1 extracts a one-time SSID generated by the reservation apparatus 6 from reservation information obtained from the reservation apparatus 6, and stores the one-time SSID as one of the other parameters in the reservation information DB 121. Then, the relay apparatus 1 sets the one-time SSID to a wireless access point that may be connected in the above-described booth by the reserved start time. Accordingly, by operating the terminal 4 at the start time to try to establish a connection using this one-time SSID, the user who knows this one-time SSID is solely able to connect to the relay apparatus 1 via the wireless access point.

Note that the reservation apparatus 6 may include, instead of or in addition to the one-time SSID, the media access control (MAC) address of the terminal 4 reserved by the user in the reservation information. In this case, the relay apparatus 1 may perform so-called MAC address filtering that discriminates the to-be-connected terminal 4 using the MAC address included in the obtained reservation information.

In addition, in the case where the security policy DB 623 permits a user who has made a reservation to add a terminal, the reservation apparatus 6 may include information indicating that fact in the reservation information.

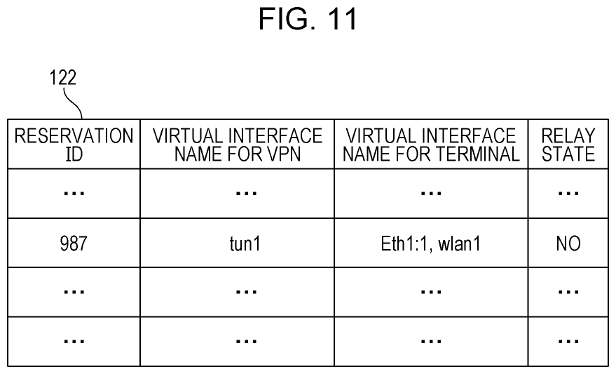

FIG. 11 is a diagram illustrating an example of the relay state DB 122. The relay state DB 122 is a database that monitors and stores the relay state when the relay apparatus 1 configures a VPN and relays communication between the terminal 4 and the server apparatus 2 over a period reserved by reservation information.

In the relay state DB 122 illustrated in FIG. 11, a reservation ID is an item common to a reservation ID indicated in the reservation information DB 121, and is registered in the relay state DB 122 in a reserved period indicated by reservation information in the reservation information DB 121. In this exemplary embodiment, the relay apparatus 1 registers this reservation information in the relay state DB 122 illustrated in FIG. 11, configures a VPN, and tries to start relaying from a time earlier by a predetermined time than the start time reserved by the reservation information, such as five minutes before the start time.

In the relay state DB 122 illustrated in FIG. 11, a virtual interface name for VPN is the name of a virtual interface used by the server apparatus 2 in a VPN configured in response to a reservation identified by a corresponding reservation ID. A virtual interface is obtained by virtualizing, with the use of software, a physical interface called a network interface card (NIC), a network card, or a LAN card.

In the relay state DB 122 illustrated in FIG. 11, a virtual interface name for terminal is the name of a virtual interface used by the terminal 4 in the above-mentioned VPN. A relay state is information indicating the communication state between the terminal 4 and the server apparatus 2, which is relayed by the above-mentioned VPN. For example, in the example illustrated in FIG. 11, a reservation with the reservation ID “987” configures a virtual interface with the name “tun1” in the server apparatus 2, and configures a virtual interface with the name “Eth1:1, wlan1” in the terminal 4. In the example illustrated in FIG. 11, the relay state between the terminal 4 and the server apparatus 2, which is based on the reservation with the reservation ID “987”, is “NO”, indicating that some kind of failure has occurred.

### Functional Configuration of Reservation Apparatus

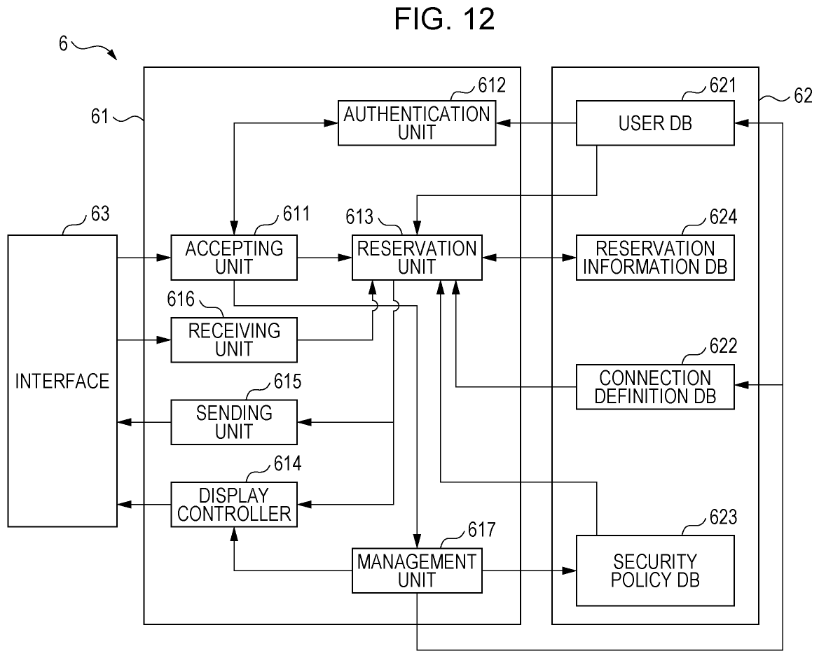

FIG. 12 is a diagram illustrating an exemplary functional configuration of the reservation apparatus 6. The processor 61 of the reservation apparatus 6 executes a program stored in the memory 62, thereby functioning as an accepting unit 611, an authentication unit 612, a reservation unit 613, a display controller 614, a sending unit 615, a receiving unit 616, and a management unit 617.

The accepting unit 611 accepts various items of information regarding a connection using a VPN from the terminal 4 via the interface 63 and the communication line 5. Information accepted by the accepting unit 611 mainly includes authentication information for proving that the user is a person who is authorized to make a reservation, reservation information indicating a reservation requested from the user, and information of an inquiry requesting to check whether there is reservation information requested to the relay apparatus 1, which is accepted from the relay apparatus 1.

For example, the processor 61 executes a so-called web server and runs a server-side script on the web server. The server-side script interacts with the web browser running on the terminal 4, and displays, on the display 45 of the terminal 4, forms, buttons, and so forth for allowing the user to input various types of information regarding a reservation. When the accepting unit 611 accepts a reservation, the reservation apparatus 6 and the terminal 4 may communicate with each other using, for example, Hypertext Transfer Protocol Secure (HTTPS) or the like.

When the accepting unit 611 has accepted authentication information, the authentication unit 612 refers to the user DB 621 and performs authentication based on this authentication information. When the authentication is successful, the authentication unit 612 permits the accepting unit 611 to accept the reservation.

When the accepting unit 611, permitted by the authentication unit 612, has accepted, for example, reservation information from the terminal 4 connected to the second communication network 7, via the communication line 5 and the interface 63, the reservation unit 613 temporarily registers the reservation information in the reservation information DB 624. The user at least designates the server apparatus 2 managed in an organization to which the user belongs, the terminal 4 used by the user, and a period in which the server apparatus 2 and the relay apparatus 1 are connected over a VPN, and reserves the period. In short, the reservation apparatus 6 including the processor 61 functioning as the accepting unit 611 and the reservation unit 613 is an example of a reservation apparatus that accepts, from a user, reservation information that designates a server apparatus managed in an organization to which the user belongs, a terminal, and a period in which the server apparatus and a relay apparatus are connected over a VPN.

In addition, on receipt of an inquiry from the relay apparatus 1 at, for example, regular intervals asking for the presence of reservation information, the reservation unit 613 refers to the reservation information DB 624 and checks the presence of reservation information requested to the relay apparatus 1. When there is such reservation information, the reservation unit 613 refers to the user DB 621, the connection definition DB 622, and the security policy DB 623, adds various types of information in accordance with the content of the reservation information to the reservation information, and allows the sending unit 615 to send the information.

When being sent to the relay apparatus 1, various types of information added to the reservation information may include, for example, the connection method, the connection ID, the connection key, and other parameters stored in the connection definition DB 622. In this case, the reservation unit 613 may search the connection definition DB 622 using, as a key, the server ID included in the reservation information stored in the reservation information DB 624, and identify the connection system, the connection ID, the connection key, and other parameters corresponding to the server ID.

In addition, various types of information described above may include detailed settings such as breakout and access restriction stored in the security policy DB 623. In this case, the reservation unit 613 may search the user DB 621 using, as a key, the user ID included in the reservation information stored in the reservation information DB 624, and identify the company name of a company to which the user identified by the user ID belongs, and a user attribute indicating the user's attribute. The reservation unit 613 may simply identify the detailed settings in accordance with the company name and the user attribute from the security policy DB 623.

The display controller 614 generates and sends information of a screen displayed on the display 45 of the terminal 4 via the interface 63 and the communication line 5. For example, in response to a request made at first from the terminal 4 for connecting to the Uniform Resource Identifier (URI) of the reservation apparatus 6, the display controller 614 generates a log-in screen asking for authentication information and sends the log-in screen to the terminal 4. In addition, when the accepting unit 611 is permitted by the authentication unit 612, the display controller 614 generates a reservation screen for inputting various types of information regarding a reservation and sends the reservation screen to the terminal 4.

When the reservation unit 613 confirms that reservation information indicated in an inquiry accepted from the relay apparatus 1 is included in the reservation information DB 624, the sending unit 615 sends the reservation information including various types of information added as described above to the relay apparatus 1 which is the inquirer. The reservation apparatus 6 including the processor 61 functioning as the sending unit 615 is an example of a reservation apparatus that sends accepted reservation information to a relay apparatus.

The receiving unit 616 receives, from the relay apparatus 1, a reply to accept or reject reservation information sent to the relay apparatus 1 in response to an inquiry. When the receiving unit 616 receives a reply to accept reservation information, the reservation unit 613 updates the reservation information in the reservation information DB 624 from the temporarily-registered state to the registered state. In contrast, when the receiving unit 616 receives a reply to reject reservation information, the reservation unit 613 deletes the reservation information in the reservation information DB 624.

When a user who has been successfully authenticated has administrator authority and makes a request to manage data based on the administrator authority, the management unit 617 performs a management process in accordance with a user operation accepted by the accepting unit 611. In the management process, the user DB 621, the connection definition DB 622, and the security policy DB 623 are edited and updated in accordance with a user operation. When performing the management process, the management unit 617 instructs the display controller 614 to generate a management screen for accepting a user operation regarding the management process and to send the management screen to the terminal 4 via the interface 63.

### Functional Configuration of Relay Apparatus

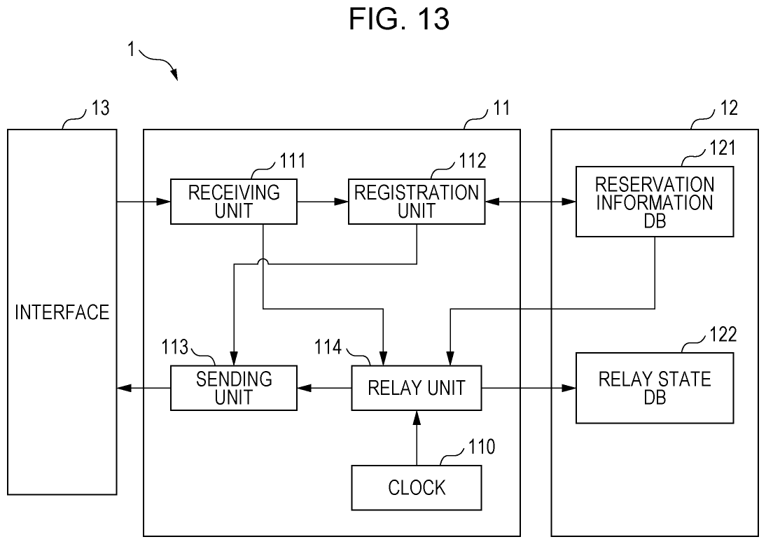

FIG. 13 is a diagram illustrating an exemplary functional configuration of the relay apparatus 1. The processor 11 of the relay apparatus 1 executes a program stored in the memory 12, thereby functioning as a receiving unit 111, a registration unit 112, a sending unit 113, and a relay unit 114.

The receiving unit 111 receives reservation information from the reservation apparatus 6 via the interface 13 and the communication line 5. The received reservation information is reservation information in the temporarily-registered state, which is sent by the reservation apparatus 6 in response to an inquiry from the relay apparatus 1. This reservation information at least includes the server ID, the terminal ID, the start time, and the end time. In short, the processor 11 functioning as the receiving unit 111 is an example of a processor configured to receive reservation information that designates a server apparatus, a terminal connected to a relay apparatus by a communication network, and a period in which the server apparatus and the relay apparatus are connected over a VPN, and that reserves the period.

Here, reservation information received by the receiving unit 111 illustrated in FIG. 13 includes various types of information added by the reservation apparatus 6. These various types of information are code used when configuring a VPN. In short, the processor 11 functioning as the receiving unit 111 is an example of a processor configured to receive reservation information that designates code used for a VPN.

In addition, the receiving unit 111 receives a request for a connection using a VPN to the server apparatus 2 from the terminal 4 via the first communication network 3 and the interface 13. The user may use code used for configuring a VPN to make this request for a connection.

When the receiving unit 111 receives reservation information from the reservation apparatus 6, the registration unit 112 refers to the reservation information DB 121 and checks whether there is a facility that may use the designated terminal 4 in a period from the start time to the end time indicated by the reservation information. In the case where it is determined that there is such a facility, the registration unit 112 accepts a reservation indicated by the reservation information and registers the reservation information in the reservation information DB 121. In contrast, in the case where it is determined that there is no facility mentioned above, the registration unit 112 rejects a reservation indicated by the reservation information. The result of determination by the registration unit 112 as to whether to accept or reject the reservation information is sent back by the sending unit 113 to the reservation apparatus 6.

The sending unit 113 makes an inquiry mentioned above to the reservation apparatus 6 at regular intervals, for example. In addition, the sending unit 113 sends the result of determination by the registration unit 112 as to whether to accept or reject the reservation information back to the reservation apparatus 6, as described above.

In this exemplary embodiment, the relay unit 114 collates time information generated by the clock 110 with the reservation information DB 121, and determines whether the current time indicated by the time information is past the time earlier by a predetermined time than the start time included in any of items of reservation information registered in the reservation information DB 121. This “predetermined time” is, for example, five minutes.

In short, the relay unit 114 determines whether it is past the time based on the start time of a reservation indicated by any of items of reservation information. If it is determined that it is past the time based on the start time of a reservation, the relay unit 114 starts configuring a VPN between the relay apparatus 1 and the server apparatus 2 from the sending unit 113 via the interface 13, the communication line 5, and the second communication network 7. This enhances the possibility of completion of the configuration of a VPN at the time point of the start time indicated in the reservation, which makes it easier for the user to immediately use the server apparatus 2 via the terminal 4 from the reserved start time. In doing so, the user may easily handle unexpected communication troubles or the like.

That is, the processor 11 functioning as the relay unit 114 in this case is an example of a processor configured to start connecting the server apparatus and the relay apparatus over a VPN from the time earlier by a predetermined time than the start time of a period designated by the received reservation information. Note that the relay unit 114 may start configuring a VPN mentioned above after the current time is past the start time.

In addition, when the receiving unit 111 receives a request for a connection using a VPN to the server apparatus 2 from the terminal 4, the relay unit 114 determines whether the connection indicated in this request is based on reservation information registered in the reservation information DB 121.

For example, in the case where the above-mentioned request is made in a period from the start time to the end time of any of items of reservation information registered in the reservation information DB 121, the relay unit 114 determines that the connection indicated in this request is based on reservation information registered in the reservation information DB 121.

Note that the relay unit 114 may have a criterion for determination mentioned above, other than the timing of making a request. For example, in the case where the user makes a request for a connection mentioned above using code used in configuring a VPN, such as the connection ID or the connection key of a VPN, the relay unit 114 collates code such as the connection ID or the connection key included in reservation information stored in the reservation information DB 121 with code used in the request. If these two pieces of code match, the relay unit 114 may determine that the connection indicated in the request is based on reservation information registered in the reservation information DB 121.

In this case, the processor 11 functioning as the relay unit 114 is an example of a processor configured to, in response to a request for a connection from a terminal in a period using code designated by the received reservation information, relay communication between the terminal and the server apparatus.

Here, the connection system of a VPN may be used as the above-mentioned code. In this case, the code is an example of code including information indicating a system of the VPN.

In the case where a set of the connection ID and the connection key of a VPN is used as the above-mentioned code, this set is information used in authenticating a user of the VPN. That is, in this case, the above-mentioned code is an example of code including information used in authenticating a user of the VPN.

In response to determination that a request received by the receiving unit 111 is based on reservation information registered in the reservation information DB 121, the relay unit 114 starts relaying the requested connection between the terminal 4 and server apparatus 2 over an already-configured VPN. After the start of the relay, the sending unit 113 sends information received by the receiving unit 111 from the terminal 4 to the server apparatus 2, and sends information received by the receiving unit 111 from the server apparatus 2 to the terminal 4.

In addition, the relay unit 114 determines whether the current time indicated by time information generated by the clock 110 is past the end time included in the above-mentioned reservation information. In the case where it is determined that the current time is past the end time, the relay unit 114 ends relaying the connection between the terminal 4 and the server apparatus 2. Accordingly, the relay unit 114 connects the server apparatus 2 and the relay apparatus 1 over a VPN and relays communication between the terminal 4 and the server apparatus 2 over a period from the start time to the end time indicated by the above-mentioned reservation.

In short, the processor 11 functioning as the relay unit 114 is an example of a processor configured to, in response to a request, in a period designated by received reservation information, from a terminal designated by the reservation information for a connection over a VPN to a server apparatus designated by the reservation information, connect the server apparatus and a relay apparatus over the VPN and relay communication between the terminal and the server apparatus over the period.

The relay unit 114 may apply, in the case where reservation information received by the receiving unit 111 from the reservation apparatus 6 designates the setting of the first communication network 3, the designated setting to the first communication network 3 when relaying communication between the terminal 4 and the server apparatus 2.

For example, out of the four detailed settings described above, breakout, access restriction, and multiple VPN are all detailed settings for the VPN itself; however, the stealth function is the detailed setting for the first communication network 3 connecting the relay apparatus 1 and the terminal 4.

Therefore, for example, in the case where the received reservation information includes a setting that enables the stealth function as the detailed setting, when the relay unit 114 relays communication between the terminal 4 and the server apparatus 2 corresponding to this reservation information, the relay apparatus 1 may simply instruct the access point of the first communication network 3 connected to the terminal 4 to enable the stealth function. Accordingly, when the user establishes a connection from the terminal 4 connected to the first communication network 3 of the client organization Gc to the server apparatus 2 over a VPN via the relay apparatus 1, the communication line 5, and the second communication network 7, the user may set the first communication network 3 connecting the terminal 4 and the relay apparatus 1.

In short, the processor 11 functioning as the relay unit 114 is an example of a processor configured to, in response to a request for a connection from a terminal in a reserved period, apply a setting designated by received reservation information to a communication network that connects a relay apparatus and the terminal and relay communication between the terminal and a server apparatus. In addition, in the case where the receiving unit 111 receives reservation information including a detailed setting that designates enabling/disabling of the stealth function of the first communication network 3, the processor 11 functioning as the receiving unit 111 is an example of a processor configured to receive reservation information that designates a setting of a communication network.

### Operation of Reservation Apparatus

The processor 61 of the reservation apparatus 6 performs an authentication process, a reservation process, a reservation information sending process, and a reservation information registering process at a reservation stage for accepting a reservation for a connection from a user.

### Operation of Authentication Process

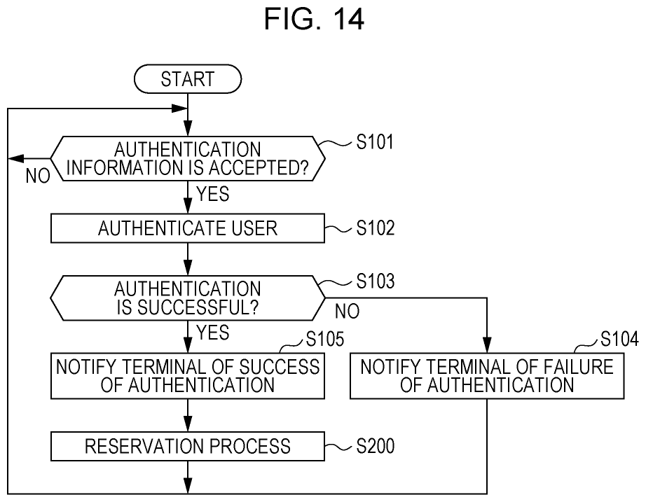

FIG. 14 is a flowchart illustrating an exemplary flow of the operation of an authentication process performed by the reservation apparatus 6. The processor 61 of the reservation apparatus 6 determines whether authentication information has been accepted from the terminal 4 connected via the communication line 5 and the interface 63 (step S101). Over a period in which it is determined that no authentication information has been accepted (NO in step S101), the processor 61 repeats this determination.

In contrast, in the case where it is determined that authentication information has been accepted (YES in step S101), the processor 61 performs authentication of the user using the accepted authentication information (step S102). The processor 61 determines whether the authentication in step S102 is successful (step S103).

In the case where it is determined that the authentication is not successful (NO in step S103), the processor 61 notifies the terminal 4, which has sent the authentication information, of the failure of the authentication (S104).

In contrast, in the case where it is determined that the authentication is successful (YES in step S103), the processor 61 notifies the above-described terminal 4 of the success of the authentication (step S105), and executes a reservation process (step S200).

### Operation of Reservation Process

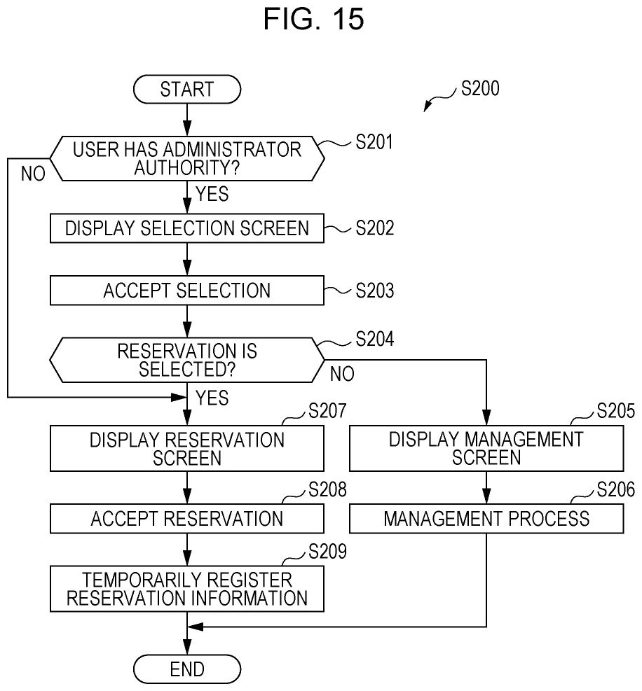

FIG. 15 is a flowchart illustrating an exemplary flow of the operation of a reservation process performed by the reservation apparatus 6. FIG. 15 illustrates the details of step S200 in FIG. 14.

The processor 61 determines whether the user who has been successfully authenticated has administrator authority (step S201). In the case where it is determined that the user has no administrator authority (NO in step S201), the processor 61 advances the process to step S207.

In contrast, in the case where it is determined that the user has administrator authority (YES in step S201), the processor 61 displays a selection screen for selecting either of acceptance of a reservation and acceptance of a command to manage various settings regarding a reservation (step S202), and accepts a selection made by the user (step S203).

The processor 61 determines whether the user has selected acceptance of a reservation in step S203 (step S204). In the case where it is determined that the user has not selected acceptance of a reservation (NO in step S204), the processor 61 displays, on the terminal 4, a management screen for accepting a command to manage various settings regarding a reservation (step S205), and executes a management process (step S206).

In contrast, in the case where it is determined that the user has selected acceptance of a reservation (YES in step S204), and in the case where it is determined in step S201 described above that the user has no administrator authority, the processor 61 displays, on the terminal 4, a reservation screen for designating the server ID of the server apparatus 2, the terminal ID of the terminal 4 connected to the relay apparatus 1 by the first communication network 3, and a period in which the server apparatus 2 and the relay apparatus 1 are connected over a VPN, and for reserving the period (step S207), and accepts a reservation made by the user (step S208).

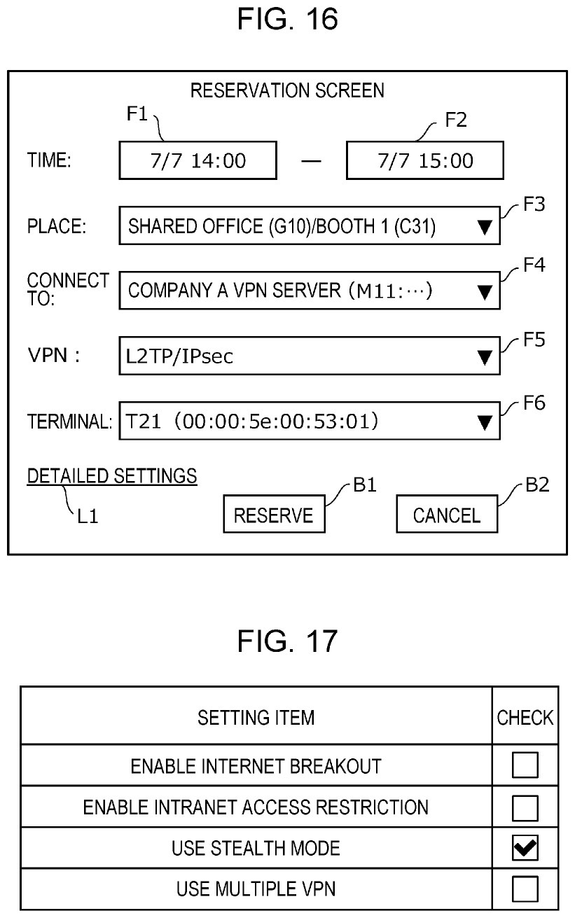

FIG. 16 is a diagram illustrating an example of the reservation screen. In FIG. 16, an input field F1 is a field for inputting the start time of the reservation, and an input field F2 is a field for inputting the end time of the reservation.

An input field F3 is a field for inputting the designation of the client organization Gc which is to be reserved. A shared office (G10) is, for example, the client organization Gc identified by the identification information “G10”. The client organization Gc identified by “G10” has the relay apparatus 1 identified by the relay apparatus ID “R1”. The input field F3 is a so-called pull-down menu for selecting any of predetermined multiple choices. The input field F3 is set in advance by the administrator of a company to which the authorized user belongs. “Booth (C31)” in the input field F3 indicates a booth identified by the identification information “C31”.

An input field F4 is a field for inputting the designation of the server apparatus 2 at the connection destination which is to be reserved. “Company A VPN server (M11): . . . ” in the input field F4 indicates the server apparatus 2 identified by the identification information “M11”.

An input field F5 is a field for inputting the designation of the connection system of a VPN, which is requested to be configured in response to the reservation. In this field, for example, the server ID of the server apparatus 2 is designated, even without an operation, in conjunction with the input field F4.

An input field F6 is a field for inputting the identification information of the terminal 4 requesting a connection using a VPN with the above-mentioned server apparatus 2 in response to the reservation. “T21 (00:00:5e:00:53:01)” in the input field F6 indicates that the terminal ID of the terminal 4 making a reservation is “T21”, and the MAC address of the terminal 4 is “00:00:5e:00:53:01”.

In FIG. 16, an area L1 where the character string “detailed settings” is written is an area for inputting the detailed settings, which are requested for the first communication network 3 when the user uses a VPN. FIG. 17 is a diagram illustrating an example of the detailed settings on the reservation screen. When the above-mentioned area L1 is clicked by the user by operating the mouse or the like, the terminal 4 causes the display 45 to display a screen illustrated in FIG. 17. This screen is a screen for setting breakout, access restriction, stealth function, and multiple VPN mentioned above by using corresponding checkboxes.

For example, since a checkbox corresponding to the setting item “enable Internet breakout” is not checked in the example illustrated in FIG. 17, breakout is disabled. Since a checkbox corresponding to the setting item “enable intranet access restriction” illustrated in FIG. 17 is not checked, access restriction is disabled. Since a checkbox corresponding to the setting item “use stealth mode” illustrated in FIG. 17 is checked, the stealth function is enabled. Since a checkbox corresponding to the setting item “use multiple VPN” illustrated in FIG. 17 is not checked, the number of VPNs indicated by multiple VPN is “1”.

A button B1 illustrated in FIG. 16 is a button labeled with the character string “reserve”, and, when this is pressed, the reservation is applied with the input content. A button B2 illustrated in FIG. 16 is a button labeled with the character string “cancel” and, when this is pressed, the reservation with the input content is canceled.

In step S208 illustrated in FIG. 15, in response to acceptance of an application for a reservation from the user, the processor 61 temporarily, that is, tentatively, registers reservation information indicating the content of the accepted reservation (step S209). The reservation information in the temporarily-registered state is not confirmed.

### Operation of Reservation Information Sending Process

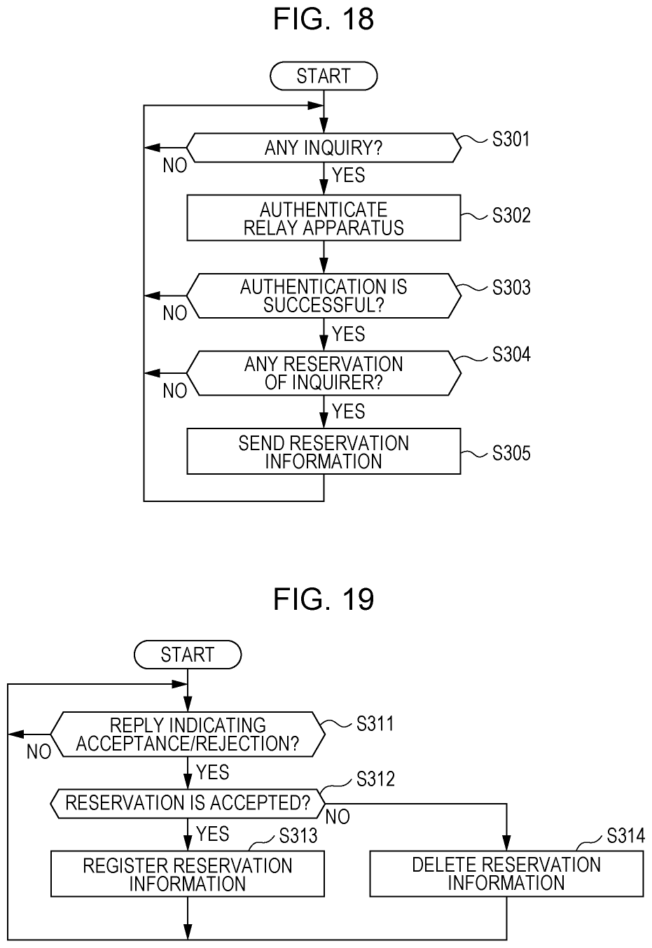

FIG. 18 is a flowchart illustrating an exemplary flow of the operation of a reservation information sending process performed by the reservation apparatus 6. The processor 61 of the reservation apparatus 6 determines whether there is an inquiry from the relay apparatus 1 via the interface 63 and the communication line 5 for checking the presence of reservation information requested to the relay apparatus 1 (step S301). Over a period in which it is determined that there is no inquiry (NO in step S301), the processor 61 repeats this determination.

In contrast, in the case where it is determined that there is an inquiry (YES in step S301), the processor 61 inspects authentication information for digest access authentication sent along with the inquiry, and authenticates the relay apparatus 1 which is the inquirer (step S302). This authentication information is not the above-mentioned authentication information of the user, but is the authentication information of the relay apparatus 1, and is, for example, a pre-shared key shared in advance between the reservation apparatus 6 and the relay apparatus 1.

Next, the processor 61 determines whether the authentication of the relay apparatus 1 in step S302 is successful (step S303). In the case where it is determined that the authentication is not successful (NO in step S303), the processor 61 returns the process back to step S301.

In contrast, in the case where it is determined that the authentication is successful (YES in step S303), the processor 61 determines whether reservation information indicating a reservation of the relay apparatus 1, which is the inquirer, is included in the reservation information DB 624 in the memory 62 (step S304). In the case where it is determined that there is no reservation information indicating a reservation of the inquirer (NO in step S304), the processor 61 returns the process back to step S301.

In contrast, in the case where it is determined that there is reservation information indicating a reservation of the inquirer (YES in step S304), the processor 61 sends the reservation information to the relay apparatus 1, which is the inquirer (step S305).

### Operation of Reservation Information Registering Process

FIG. 19 is a flowchart illustrating an exemplary flow of the operation of a reservation information registering process performed by the reservation apparatus 6. The processor 61 of the reservation apparatus 6 determines whether there is a reply to accept or reject the reservation information sent to the relay apparatus 1 in step S305 (step S311). Over a period in which it is determined that there is no reply to accept or reject the reservation information (NO in step S311), the processor 61 repeats this determination.

In contrast, in the case where it is determined that there is a reply to accept or reject the reservation information (YES in step S311), the processor 61 determines whether the reply indicates acceptance of the reservation information (step S312).

In the case where it is determined that the reply indicates acceptance of the reservation information (YES in step S312), the processor 61 registers the reservation information, which is temporarily registered in the reservation information DB 624 (step S313). That is, the processor 61 writes the reservation ID included in the reply to accept the reservation information in a corresponding field of the reservation information in the reservation information DB 624.

In contrast, in the case where it is determined that the reply does not indicate acceptance of the reservation information (NO in step S312), the processor 61 deletes the temporarily-registered reservation information from the reservation information DB 624 (step S314).

### Operation of Relay Apparatus

The processor 11 of the relay apparatus 1 receives reservation information and accepts or rejects the reservation information at a reservation stage for accepting a reservation for a connection from a user. In addition, at a use stage at which a reserved period comes and the user uses the reserved connection, the processor 11 scans the reservation information DB 121 and inspects each item of reservation information included therein.

### Operation of Accepting or Rejecting Reservation Information

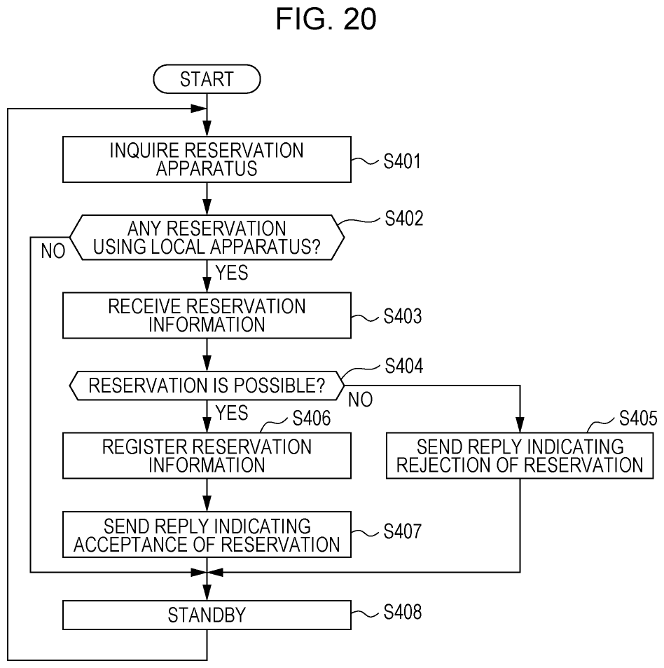

FIG. 20 is a flowchart illustrating an exemplary flow of the operation of accepting or rejecting reservation information by the processor 11. The processor 11 inquires the reservation apparatus 6 whether there is a reservation for a VPN using the relay apparatus 1 (step S401). The processor 11 receives a reply from the reservation apparatus 6, and, on the basis of this reception, determines whether there is a reservation using the relay apparatus 1 (step S402).

In the case where it is determined that there is no reservation using the relay apparatus 1 (NO in step S402), the processor 11 advances the process to step to S408.

In contrast, in the case where it is determined that there is a reservation using the relay apparatus 1 (YES in step S402), the processor 11 receives the reservation information from the reservation apparatus 6 (step S403).

Next, the processor 11 checks the content of the reservation information received from the reservation apparatus 6, and determines whether the reservation indicated by the reservation information is possible (step S404). For example, in the case where all booths, access points, terminals 4, and so forth have been reserved and there is no availability in a period requested by the reservation, the relay apparatus 1 determines that the reservation is not possible.

In the case where it is determined that the reservation is not possible (NO in step S404), the processor 11 sends a reply to reject the reservation indicated by the reservation information to the reservation apparatus 6 (step S405).

In contrast, in the case where it is determined that the above-mentioned reservation is possible (YES in step S404), the processor 11 registers the reservation information in the reservation information DB 121 (step S406), and sends a reply to accept the reservation indicated by the reservation information to the reservation apparatus 6 (step S407).

After it is determined that there is no reservation using the local apparatus in step S402, after a reply to reject the reservation is sent in step S405, and after a reply to accept the reservation is sent in step S407, the processor 11 waits for a predetermined time, such as 60 seconds (step S408), and then returns the process back to step S401.

### Operation of Scanning Database

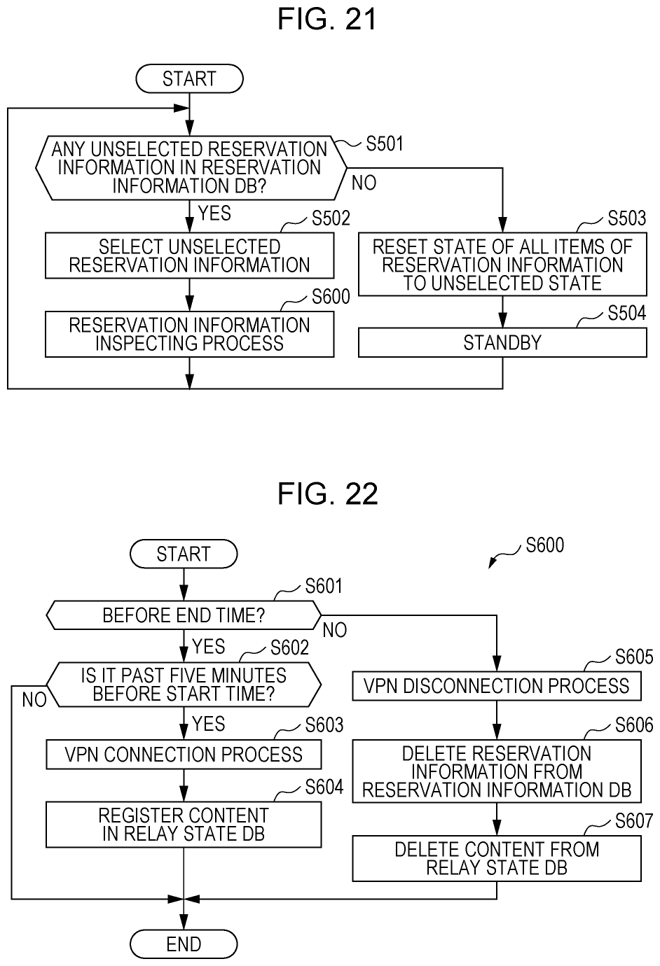

FIG. 21 is a flowchart illustrating an exemplary flow of the operation of scanning a database. The processor 11 determines whether there is unselected reservation information in the reservation information DB 121 (step S501). Here, the target of the determination is all items of reservation information stored in the reservation information DB 121. The RAM of the memory 12 stores the state of selection of each of these all items of reservation information.

In the case where it is determined that there is unselected reservation information in the reservation information DB 121 (YES in step S501), the processor 11 selects one item of unselected reservation information (step S502), and performs a process of inspecting the reservation information (step S600).

In contrast, in the case where it is determined that there is no unselected reservation information in the reservation information DB 121 (NO in step S501), the processor 11 resets the state of all items of reservation information stored in the RAM of the memory 12 to the unselected state (step S503). The processor 11 waits for a predetermined time (step S504), and returns the process back to step S501. Accordingly, the reservation information included in the reservation information DB 121 is scanned one at a time every time period mentioned above, and an inspection process is performed.

### Operation of Performing Reservation Information Inspecting Process

FIG. 22 is a flowchart illustrating an exemplary flow of the operation of a process of inspecting selected reservation information. The processor 11 obtains time information generated by the clock 110, and determines whether the current time indicated by the time information is earlier than the end time included in the selected reservation information (step S601). In the case where it is determined that the current time is earlier than the above-mentioned end time (YES in step S601), the processor 11 determines whether the current time is past five minutes before the start time included in the above-mentioned reservation information (step S602). Five minutes before the start time is an example of a time based on the current time, and is an example of a time earlier by a predetermined time than the start time of a reserved period.

In the case where it is determined that the current time is not past five minutes before the start time (NO in step S602), the processor 11 ends the process.

In contrast, in the case where it is determined that the current time is past five minutes before the start time (YES in step S602), the processor 11 performs a VPN connection process (step S603). This VPN connection process is a process of configuring a VPN between the relay apparatus 1 and the server apparatus 2 designated by the reservation information. Using the configured VPN, the processor 11 relays communication the server apparatus 2 and the terminal 4 designated by the reservation, monitors the relay state, and registers the monitored content in the relay state DB 122 (step S604).

In contrast, in the case where it is determined that the current time is not before the above-mentioned end time (NO in step S601), the processor 11 performs a VPN disconnection process (step S605). This VPN disconnection process is a process of canceling the configured VPN and disconnecting communication between the server apparatus 2 and the terminal 4. The processor 11 deletes the reservation information from the reservation information DB 121 (step S606), and deletes content registered in the relay state DB 122 regarding this reservation information (step S607). Accordingly, the reserved connection is disconnected after the current time is past the end time indicated by the reservation information.

Note that, in the case where the above-mentioned reservation information includes information indicating that the user is permitted to add a terminal, the terminal 4 is allowed to send a request for extending the connection to the relay apparatus 1 in a reserved period and in a predetermined period after the end of the reserved period. In this case, after the current time is past the end time indicated by the reservation information, the relay apparatus 1 suspends deletion of the reservation information and puts it in a disabled state over the above-mentioned period. On receipt of a request for extending the connection within this period, the relay apparatus 1 may simply restore the reservation information, which has been put into a disabled state, in the reservation information DB 121 to be enabled, and cancel the deletion.

With the above-described operation, when a period reserved by the reservation apparatus 6 comes, the relay apparatus 1 configures a VPN between the server apparatus 2 designated by the reservation and the relay apparatus 1. The relay apparatus 1 permits the terminal 4, which is connected to the relay apparatus 1 with the reserved content, to establish a connection to the server apparatus 2 using the VPN. Accordingly, the user of the relay system 9 is able to connect to the server apparatus 2 belonging to the server organization Gs from the terminal 4 over a VPN, even if the user does not set the terminal 4.

In addition, the reservation apparatus 6 authenticates a user by performing collation with authentication information stored in the reservation apparatus 6 and sends reservation information to the relay apparatus 1, thereby permitting the user the authority to allow the relay apparatus 1 to configure a VPN and to relay communication between the terminal 4 and the server apparatus 2. Accordingly, the relay apparatus 1 need not include the user's authentication information.

In addition, in the case where the terminal 4 is provided in advance in the client organization Gc such as a shared office, the terminal 4 is used by an unspecified number of users. Therefore, the terminal 4 lent out in the client organization Gc is generally configured to delete settings unique to each user every time the user finishes using the terminal 4. Therefore, in the case where the related art is used, a user who borrows a terminal in a shared office or the like and uses a VPN is required to set a VPN client every time a VPN is configured. In the relay system 9 according to the present disclosure, since the relay apparatus 1 performs a task corresponding to the setting of a VPN client by using reservation information in place of the target terminal 4, the user's burden is reduced, in terms of setting a VPN client, as compared with the case where there is no such a configuration.

### Modifications

The content of the above-described exemplary embodiment may be modified as below. In addition, the following modifications may be combined with one another.

### First Modification

Although the relay apparatus 1 includes the processor 11 including a CPU in the above-described exemplary embodiment, a controller that controls the relay apparatus 1 may be other configurations. For example, the relay apparatus 1 may include various processors other than a CPU.

Here, the processor refers to a processor in a broad sense, and includes general processors (such as the above-mentioned CPU) and dedicated processors (such as a graphics processing unit (GPU), an application specific integrated circuit (ASIC), a field programmable gate array (FPGA), and a programmable logic device).

### Second Modification

The operation of the processor 11 in the above-described exemplary embodiment may be implemented not only by one processor 11, but by plural processors in collaboration which are located physically apart from each other but may work cooperatively.

The order of operations of the processor is not limited to one described in the exemplary embodiment above, and may be changed as appropriate.

### Third Modification

In the above-described exemplary embodiment, in the case where the received reservation information is encrypted, the processor 11 of the relay apparatus 1 may decrypt the reservation information. For example, although the relay apparatus 1 and the reservation apparatus 6 use digest access authentication in the above-described exemplary embodiment, communication after successful authentication based on digest access authentication may be encrypted with a protocol such as Transport Layer Security (TLS).

Although an inquiry from the relay apparatus 1 is periodically checked by the reservation apparatus 6 and reservation information is sent from the reservation apparatus 6 to the relay apparatus 1, reservation information may be distributed from the reservation apparatus 6 to each relay apparatus 1. For example, the above-mentioned reservation information may be sent by the reservation apparatus 6 to each relay apparatus 1 by attaching it to an email message or the like before a reservation starts. The reservation information attached to the email message may be encrypted. In this case, the relay apparatus 1 may decrypt the reservation information attached to the received email message using a pre-shared key determined with the reservation apparatus 6.

### Fourth Modification

Although the relay apparatus 1 configures a VPN on the communication line 5 and relays communication between the server apparatus 2 and the terminal 4 connected to the relay apparatus 1 by the first communication network 3, the function of the relay apparatus 1 is not limited to this function. The relay apparatus 1 may have the functions of a firewall, routing, a Dynamic Host Configuration Protocol (DHCP) server, and a wireless LAN controller.

### Fifth Modification

In the above-described exemplary embodiment, a program executed by the processor 11 of the relay apparatus 1 is an example of a program that causes a computer including a processor to execute a process including: receiving reservation information that designates a server apparatus, a terminal connected to a relay apparatus by a communication network, and a period in which the server apparatus and the relay apparatus are connected over a VPN, and that reserves the period; and, in response to a request, in the period designated by the received reservation information, from the terminal designated by the reservation information, for a connection over the VPN to the server apparatus designated by the reservation information, connecting the server apparatus and the relay apparatus over the VPN and relaying communication between the terminal and the server apparatus over the period.

The program may be provided in a state where the program is recorded on a computer-readable recording medium such as a magnetic recording medium including a magnetic tape and a magnetic disk, an optical recording medium including an optical disk, a magneto-optical recording medium, and semiconductor memory. In addition, the program may be downloaded via a communication line such as the Internet.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment(s) above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A relay apparatus comprising
a processor configured to
receive reservation information that designates a server apparatus, a terminal connected to the relay apparatus by a communication network, and a period in which the server apparatus and the relay apparatus are connected over a virtual private network (VPN), and that reserves the period, and
in response to a request, in the period designated by the received reservation information, from the terminal designated by the reservation information, for a connection over the VPN to the server apparatus designated by the reservation information, connect the server apparatus and the relay apparatus over the VPN and relay communication between the terminal and the server apparatus over the period.

2. The relay apparatus according to claim 1, wherein:
the processor is configured to
receive the reservation information designating code used for the VPN, and
in response to a request for the connection from the terminal in the period using the code designated by the received reservation information, relay communication between the terminal and the server apparatus.

3. The relay apparatus according to claim 2, wherein the code includes information indicating a system of the VPN.

4. The relay apparatus according to claim 2, wherein the code includes information used in authenticating a user of the VPN.

5. The relay apparatus according to claim 3, wherein the code includes information used in authenticating a user of the VPN.

6. The relay apparatus according to claim 1, wherein:
the processor is configured to
receive the reservation information designating a setting of the communication network, and
in response to a request for the connection from the terminal in the period, apply the setting designated by the received reservation information to the communication network, and relay communication between the terminal and the server apparatus.

7. The relay apparatus according to claim 2, wherein:
the processor is configured to
receive the reservation information designating a setting of the communication network, and
in response to a request for the connection from the terminal in the period, apply the setting designated by the received reservation information to the communication network, and relay communication between the terminal and the server apparatus.

8. The relay apparatus according to claim 3, wherein:
the processor is configured to
receive the reservation information designating a setting of the communication network, and
in response to a request for the connection from the terminal in the period, apply the setting designated by the received reservation information to the communication network, and relay communication between the terminal and the server apparatus.

9. The relay apparatus according to claim 4, wherein:
the processor is configured to
receive the reservation information designating a setting of the communication network, and
in response to a request for the connection from the terminal in the period, apply the setting designated by the received reservation information to the communication network, and relay communication between the terminal and the server apparatus.

10. The relay apparatus according to claim 5, wherein:
the processor is configured to
receive the reservation information designating a setting of the communication network, and
in response to a request for the connection from the terminal in the period, apply the setting designated by the received reservation information to the communication network, and relay communication between the terminal and the server apparatus.

11. The relay apparatus according to claim 1, wherein the processor is configured to start connecting the server apparatus and the relay apparatus over the VPN from a time earlier by a predetermined time than a start time of the period designated by the received reservation information.

12. The relay apparatus according to claim 2, wherein the processor is configured to start connecting the server apparatus and the relay apparatus over the VPN from a time earlier by a predetermined time than a start time of the period designated by the received reservation information.

13. The relay apparatus according to claim 3, wherein the processor is configured to start connecting the server apparatus and the relay apparatus over the VPN from a time earlier by a predetermined time than a start time of the period designated by the received reservation information.

14. The relay apparatus according to claim 4, wherein the processor is configured to start connecting the server apparatus and the relay apparatus over the VPN from a time earlier by a predetermined time than a start time of the period designated by the received reservation information.

15. The relay apparatus according to claim 5, wherein the processor is configured to start connecting the server apparatus and the relay apparatus over the VPN from a time earlier by a predetermined time than a start time of the period designated by the received reservation information.

16. The relay apparatus according to claim 6, wherein the processor is configured to start connecting the server apparatus and the relay apparatus over the VPN from a time earlier by a predetermined time than a start time of the period designated by the received reservation information.

17. The relay apparatus according to claim 1, wherein the processor is configured to, in a case where the received reservation information is encrypted, decrypt the reservation information.

18. A relay system comprising:
a reservation apparatus; and
a relay apparatus, wherein:
the reservation apparatus is configured to
send, to the relay apparatus, reservation information that designates a server apparatus, a terminal connected to the relay apparatus by a communication network, and a period in which the server apparatus and the relay apparatus are connected over a VPN, and that reserves the period, and
the relay apparatus is configured to
receive the reservation information from the reservation apparatus, and
in response to a request, in the period designated by the received reservation information, from the terminal designated by the reservation information, for a connection over the VPN to the server apparatus designated by the reservation information, connect the server apparatus and the relay apparatus over the VPN and relay communication between the terminal and the server apparatus over the period.

19. The relay system according to claim 18, wherein:
the reservation apparatus is configured to
accept, from a user, the reservation information designating the server apparatus managed in an organization to which the user belongs, the terminal, and the period, and
send the accepted reservation information to the relay apparatus.

20. A non-transitory computer readable medium storing a program causing a computer including a processor to execute a process, the process comprising:
receiving reservation information that designates a server apparatus, a terminal connected to a relay apparatus by a communication network, and a period in which the server apparatus and the relay apparatus are connected over a virtual private network (VPN), and that reserves the period; and
in response to a request, in the period designated by the received reservation information, from the terminal designated by the reservation information, for a connection over the VPN to the server apparatus designated by the reservation information, connecting the server apparatus and the relay apparatus over the VPN and relaying communication between the terminal and the server apparatus over the period.
